(19) United States
(12) Patent Application Publication
(10) Pub. No.: US 2009/0005205 A1
(43) Pub. Date: Jan. 1, 2009

(54) Power transmission device

(75) Inventor: Yasuhiko Fujita, Moriyama-shi (JP)

Correspondence Address: GLOBAL IP COUNSELORS, LLP, 1233 20TH STREET, NW, SUITE 700, WASHINGTON, DC, 20036-2680, US

(73) Assignee: Exedy Corporation

(21) Appl. No.: 11/882,377

(22) Filed: Aug. 1, 2007

(30) Foreign Application Priority Data
Aug. 1, 2006 (JP) JP 2006-209638

(51) Int. Cl. F16H 1/28

(52) U.S. Cl. 475/11

(57) ABSTRACT

A power transmission device is provided to transmit power from an engine to a transmission, including a transmission mechanism, a first clutch, a second clutch, a damper mechanism, and a casing. The transmission mechanism is configured to transmit power with two kinds of rotational speeds that vary in stages. The first clutch is configured to switch rotational speed in the transmission mechanism to decrease the speed ratio. The second clutch is configured to set the rotational speed ratio of the transmission mechanism so that output rotational speed equals input rotational speed, that is, the transmission mechanism is in a fixed state.

### CROSS-REFERENCE TO RELATED APPLICATIONS

This application claims priority to Japanese Patent Application No. 2006-209638 filed on Aug. 1, 2006. The entire disclosure of Japanese Patent Application No. 2006-209638 is hereby incorporated herein by reference.

### BACKGROUND OF THE INVENTION

1. Field of the Invention

The present invention relates to a power transmission device. More specifically, the present invention relates to a power transmission device included in an automatic transmission device to transmit power from an engine to a transmission.

2. Background Information

In view of increasing awareness regarding the environmental protection, an improved fuel efficiency of vehicles is highly expected by modern day consumers.

On the other hand, demand for automatic transmission devices with Continuously Variable Transmissions (“CVT” hereinafter), in addition to Automatic Transmissions (“AT” hereinafter), is increasing.

In such automatic transmission devices, a hydrodynamic power transmission device is employed to achieve a smooth start of the vehicle and to absorb smoothly rotational speed differences of between an engine and a transmission during gear shifting.

Conventionally, the hydrodynamic power transmission device provides increasing torque activity using fluid, with a lock-up device to improve power transmission efficiency while a vehicle is running at a steady speed. A known hydrodynamic power transmission system of the above kind is described in Japanese Unexamined Patent Publication No. 2005-133731.

This known device employs a torque converter, including a front cover, an impeller, a turbine, a stator, and a lock-up device. The front cover with the impeller fixed to it is configured to form a fluid chamber therewith, and receives power from the engine. The turbine is arranged between the front cover and the impeller to be coupled to the input shaft of the transmission, the stator is arranged between the impeller and the turbine to regulate the flow of operating oil from the turbine to the impeller, and the lock-up device is arranged between the front cover and the turbine so that it can couple the front cover to the turbine.

Rotation of the impeller allows operating oil to flow from the impeller to the turbine, whereby power is transmitted through the operating oil from the impeller to the turbine. The vehicle starts to move as the power is transmitted from the turbine to the input shaft. When operating oil returns from the turbine to the impeller, the stator regulates the flow of operating oil, providing so-called torque increasing activity for the torque converter.

The lock-up device couples the front cover to the turbine as the rotational speed of the turbine increases, and the rotational speed difference between the impeller and the turbine decreases so that the power is directly transmitted through the lock-up device from the front cover to the turbine.

As stated, conventionally, the hydrodynamic power transmission device provides increasing torque activity using fluid, with a lock-up device to improve power transmission efficiency while a vehicle is running at a steady speed. Another known hydrodynamic power transmission system of the above kind is described in Japanese Unexamined Patent Publication No. 2005-133731.

However, compared to the devices such as a clutch that directly transmits power without fluid, the conventional hydrodynamic power transmission devices are inferior with regard to power transmission efficiency since power is transmitted through operating oil.

In view of the above, it is apparent to those skilled in the art that there exists a need for a device that allows further improved power transmission efficiency which still succeeds in securing the smooth start of the vehicle. This invention addresses this need in the art as well as other needs, which will become apparent to those skilled in the art from this disclosure.

### SUMMARY OF THE INVENTION

Therefore, it is an object of the present invention to provide an improved power transmission device included in an automatic transmission device with better power transmission efficiency that is still capable of providing smooth starts for a vehicle.

According to a first aspect of the present invention, a power transmission device is a device that transmits power from an engine to the transmission. The power transmission device includes a transmission mechanism, and at least two clutches. The transmission mechanism transmits power with at least two kinds of rotational speed ratios. Here, “rotational speed ratio” means ratio of input rotational speed to output rotational speed. “The clutch” means a mechanism that allows relative rotation in only one direction such as a one-way clutch, as well as a clutch that utilizes application of pressing force such as hydraulic pressure and an elastic member. “The transmission” means a multistage transmission with a plurality of gears, CVT, or a combination of both.

The rotational speed ratio between input rotational speed and output rotational speed varies in stages due to the clutch and the transmission mechanisms. For example, rotational speed can be transmitted from the engine to the transmission with decreasing, or rotational speed can be directly transmitted from the engine to the transmission without decreasing. Power can be outputted with decreased rotational speed by the transmission mechanism when the vehicle starts, then be directly outputted without decreasing rotational speed by the transmission mechanism. By employing this method, step by step changes of the rotational speed ratio enables improvement of power transmission efficiency with relatively smooth starts for the vehicle.

According to a second aspect of the present invention, a power transmission device is that of the first aspect, wherein the clutches participate in transmitting power indirectly. By “the clutches indirectly participate in transmitting power,” it means that the transmission mechanism mainly transmits power and the clutch is used accessorily.

In this case, a direct transmission of power through the transmission mechanism allows improvement of power transmission efficiency. Moreover, since a small clutch can be used, compatibility with the conventional hydrodynamic power transmission device can be maintained without upsizing or increasing the installation space.

According to a third aspect of the present invention, a power transmission device is that of the first or second aspect, further including a housing. The transmission mechanism includes a sun gear, a ring gear, a plurality of pinion gears, and a carrier, whereby the sun gear receives power from the engine. The ring gear is arranged radially outward of the sun gear, and the plurality of pinion gears are arranged between the sun gear and the ring gear to engage with the sun gear and the ring gear. The carrier is coupled to the member of the transmission, and also couples the plurality of pinion gears. Two clutches include at least either a first clutch capable of coupling and decoupling the ring gear and the housing, or a second clutch capable of coupling and decoupling any two of the sun gear, the ring gear, and the carrier.

This power transmission device includes the planetary gear mechanism. When the ring gear and the housing are coupled by the first clutch, the ring gear is unrotatable relative to the housing. For example, when the sun gear and the carrier are decoupled by the second clutch, the sun gear is rotatable relative to the carrier. In this case, the transmission mechanism serves as the reduction gears, and power is outputted to the transmission with decreased rotational speed.

On the other hand, when the first clutch is disengaged, the ring gear is rotatable relative to the housing. For example, when the sun gear and the carrier are coupled, and the sun gear and the member of the transmission are coupled by the second clutch, the sun gear is unrotatable relative to the carrier. In this case, since the transmission mechanism integrally rotates, power is outputted to the transmission without decreasing rotational speed. Consequently, when the sun gear receives power, the sun gear, the pinion gears and the ring gear integrally rotate, and power is transmitted from the engine to the transmission without decreasing rotational speed.

As described above, this power transmission device, albeit having a simple structure, enables gear shifting in two stages at the start of vehicle by application of the planetary gear mechanism. Moreover, this simple structure also enables the power transmission device to maintain compatibility with the conventional hydrodynamic power transmission device without upsizing the installation space. The same effect is also provided when the second clutch couples and decouples the ring gear and the carrier, or when the second clutch couples and decouples the sun gear and the ring gear.

According to a fourth aspect of the present invention, a power transmission device is that of the first or second aspect, further including a housing. The transmission mechanism includes a sun gear, a ring gear, a plurality of pinion gears, and a carrier, whereby the sun gear receives power from the engine. The ring gear is arranged radially outward of the sun gear, and the plurality of pinion gears is arranged between the sun gear and the ring gear to engage with the sun gear and the ring gear. The carrier is coupled to the member of the transmission, and also couples the plurality of pinion gears. Two clutches include at least either a first clutch that allows relative rotation between the ring gear and the housing in only one direction or a second clutch capable of coupling and decoupling any two of the sun gear, the ring gear and the carrier.

In this power transmission device, with the first clutch, the ring gear is unrotatable relative to the housing in the direction opposite to the rotational direction of the sun gear. When the second clutch decouples the sun gear and the carrier, the sun gear is rotatable relative to the carrier. In this case, the transmission mechanism serves as the reduction gears, and power is transmitted to the transmission with decreased rotational speed.

On the other hand, when the second clutch couples the sun gear to the carrier and the member of the transmission, the sun gear is unrotatable relative to the carrier. In this case, since the transmission mechanism integrally rotates, power is transmitted to the transmission without decreasing rotational speed.

As described above, this power transmission device, albeit having a simple structure, enables gear shifting in two stages at the start of vehicle by application of the planetary gear mechanism. Moreover, this simple structure also enables the power transmission device to maintain compatibility with the conventional hydrodynamic power transmission device without upsizing the installation space. The same effect is also provided when the second clutch couples and decouples the ring gear and the carrier, or when the second clutch couples and decouples the sun gear and the ring gear.

According to a fifth aspect of the present invention, a power transmission device is that of the fourth aspect, wherein the ring gear is rotatable relative to the housing in only the same direction as the rotational direction of the sun gear.

According to a sixth aspect of the present invention, a power transmission device is that of any of the first to fifth aspects, further including a damper mechanism elastically coupling the member of the engine and the member of the transmission mechanism in the rotational direction.

According to a seventh aspect of the present invention, a power transmission device is that of any of the first to sixth aspects, wherein the transmission includes a CVT.

### Effect of the Invention

The power transmission device according to the present invention enables the improvement of power transmission efficiency while still securing the smooth start of the vehicle.

These and other objects, features, aspects, and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a schematic cross-sectional view of an automatic transmission device with a power transmission device in accordance with a first preferred embodiment of the present invention;

FIG. 2 is a schematic cross-sectional view of the power transmission device in accordance with the first preferred embodiment of the present invention;

FIG. 3 is a velocity diagram of the power transmission device;

FIGS. 4a-4d are explanatory diagrams provided to illustrate gear shifting operations of the power transmission devices;

FIGS. 5a-5c are explanatory diagrams provided to illustrate the operation of a transmission mechanism of the automatic transmission device;

FIGS. 6a and 6b are explanatory diagrams provided to illustrate the operation of the transmission mechanism;

FIG. 7 is a schematic cross-sectional view of an automatic transmission device with a power transmission device in accordance with a second preferred embodiment of the present invention;

FIG. 8 is a schematic cross-sectional view of the power transmission device in accordance with the second embodiment of the present invention;

FIG. 9 is a velocity diagram of the power transmission device of FIG. 8;

FIGS. 10a-10d are explanatory diagrams provided to illustrate gear shifting operations of the power transmission device of FIG. 8;

FIGS. 11a-11c are explanatory diagrams provided to illustrate the operation of the transmission mechanism of the automatic transmission device of FIG. 7;

FIG. 12 is a schematic cross-sectional view of a power transmission device in accordance with a third preferred embodiment of the present invention; and

FIG. 13 is a schematic cross-sectional view of a power transmission device in accordance with a fourth preferred embodiment of the present invention.

### Explanation of Letters or Numbers in the FIGS.

1, 101 power transmission device; 4, 104 transmission mechanism; 5 housing; 6 damper mechanism; 7 switching mechanism; 8 engine; 9 transmission; 10 automatic transmission device; 11 sun gear; 12 pinion gear; 13 ring gear; 14 carrier; 15, 115 first clutch; 16, 216, 316 second clutch; and 17 casing.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

### 1. First Embodiment

### Overall Structure of Automatic Transmission Device

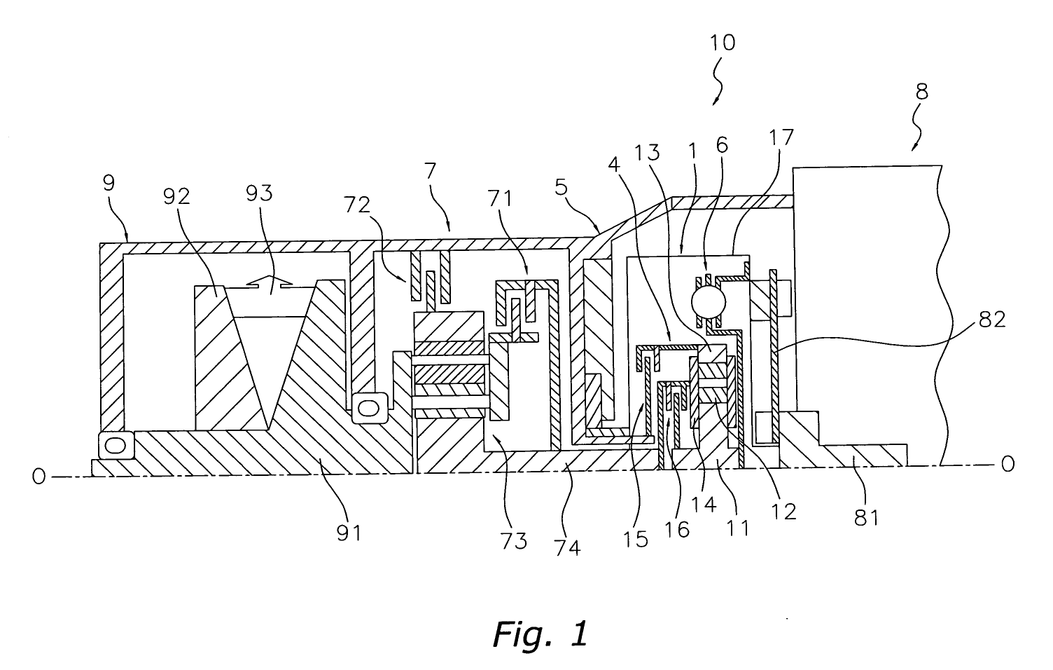

An automatic transmission device with the power transmission device according to the first embodiment of the present invention will be described with reference to FIG. 1 which illustrates a schematic cross-sectional view of an automatic transmission device 10.

The automatic transmission device 10 is a device that automatically changes rotational speed of rotational movement transmitted from an engine 8. Specifically, as shown in FIG. 1, the automatic transmission device 10 mainly includes a power transmission device 1, a transmission 9, a switching mechanism 7, and a housing 5. The power transmission device 1 transmits power from the engine 8, and the switching mechanism 7 switches the driving of a vehicle forward and backward. The transmission 9 changes input rotational speeds transmitted from the switching mechanism 7, and the housing 5 houses these structures. A flexible plate 82 is fixed to an output member 81 of the engine 8 to absorb bending vibration.

The switching mechanism 7 mainly includes a planetary gear mechanism 73 employing a double pinion type planetary gear, a forward clutch 71, and a backward clutch 72. The planetary gear mechanism 73 can switch the rotational directions of rotational movement inputted from the power transmission device 1. The forward clutch 71 is coupled when driving forward. The backward clutch 72 is coupled when driving backward. The transmission 9 is, for example, a belt type CVT, and mainly has an input pulley 91 coupled to the planetary gear mechanism 73, an output pulley (not shown), and a belt 93 belting up the input pulley 91 and the output pulley. The housing 5 is fixed to the engine 8, and supports the power transmission device 1, the switching mechanism 7, and the transmission 9. Detailed explanations will be omitted with regard to the structures of the switching mechanism 7 and the transmission 9 since their structures are the same as or similar to the conventional structures.

### Structure of Power Transmission Device

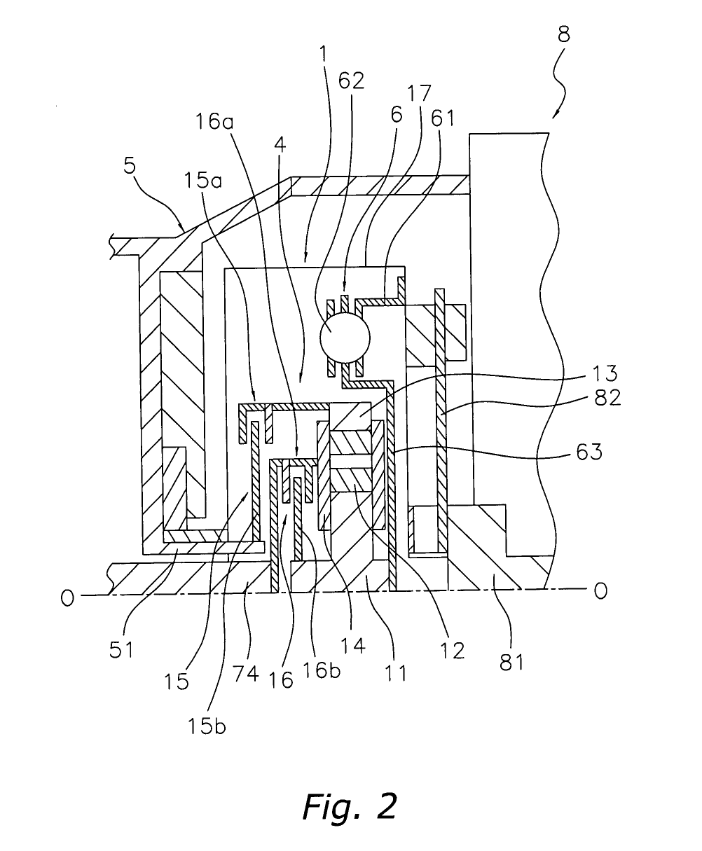

In the automatic transmission device 10, the power transmission device 1 having completely different structures is arranged at the position where the conventional hydrodynamic power transmission device is usually arranged. The structures of the power transmission device 1 will be described with reference to FIG. 2, which illustrates a schematic view of the power transmission device 1.

As seen in FIG. 1, the power transmission device 1 is a device to transmit power from the engine 8 to the transmission 9 through the switching mechanism 7. Specifically, as shown in FIG. 2, the power transmission device 1 mainly includes a transmission mechanism 4, a first clutch 15, a second clutch 16, and a casing 17. The transmission mechanism 4 transmits power with two kinds of rotational speed ratios that vary in stages. The first clutch 15 switches rotational speed ratios of the transmission mechanism 4 to decrease output rotational speed, and the second clutch 16 sets a rotational speed ratio of the transmission mechanism 4 so that output rotational speed equals to input rotational speed, that is, the transmission mechanism 4 is in the fixed state. The casing 17 is fixed to the flexible plate 82 and interiorly cases the transmission mechanism 4, the first clutch 15, and the second clutch 16. The casing 17 is supported by a cylindrical portion 51 of the housing 5 to be rotatable, and is interiorly filled with the operating oil.

The transmission mechanism 4 is preferably a planetary gear mechanism, and mainly includes a sun gear 11, a ring gear 13, a plurality of pinion gears 12, a carrier 14, and a damper mechanism 6. The sun gear 11 receives power from the engine 8 and the ring gear 13 is arranged around the sun gear 11. The plurality of pinion gears 12 is arranged between the sun gear 11 and the ring gear 13. The carrier 14 is coupled to an input member 74 of the switching mechanism 7, and couples a plurality of pinion gears 12. The damper mechanism 6 elastically couples the casing 17 and the sun gear 11 in the rotational direction. The pinion gears 12 engage with the sun gear 11 and the ring gear 13.

The rotational speed ratio of the transmission mechanism 4 is switched into two stages by the first clutch 15 and the second clutch 16. Specifically, the first clutch 15 can switch the coupled state of the ring gear 13 and the housing 5, wherein the first pressing mechanism 15 is fixed to the ring gear 13 and a first friction member 15b of the first pressing mechanism 15 is fixed to the cylindrical portion 51 of the housing 5. The second clutch 16 can switch the coupled state of the sun gear 11 and the carrier 14, wherein a second pressing mechanism 16a of the second clutch 16 is fixed to the input member 74 of the switching mechanism 7 and the carrier 14, and the second friction member 16b is fixed to the sun gear 11. A first pressing mechanism 15a and a second pressing mechanism 16a, respectively of the first clutch 15 and the second clutch 16, controlled by the hydraulic pressure, and can respectively hold the first friction member 15b and the second friction member 16b. The hydraulic pressure supplied to the first pressing mechanism 15a and the second pressing mechanism 16a can be controlled by a control valve (not shown), for example. The control valve is electrically-controlled by a control unit (not shown). These allow minute controls of the first clutch 15 and the second clutch 16 such as a half-engaged state.

The damper mechanism 6 includes a pair of input plates 61 fixed to the casing 17, an output plate 63 fixed to the sun gear 11, and a plurality of coil springs 62, whereby the output plate 63 is arranged between the input plates 61 to be rotatable respectively. The plurality of coil springs 62 elastically couple the input plate 61 and the output plate 63 in the rotational direction.

### Operation of Power Transmission Device

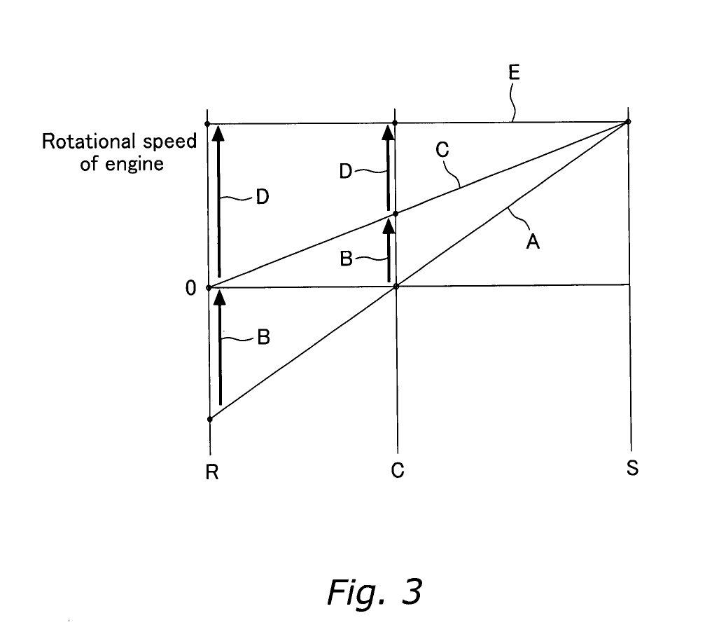

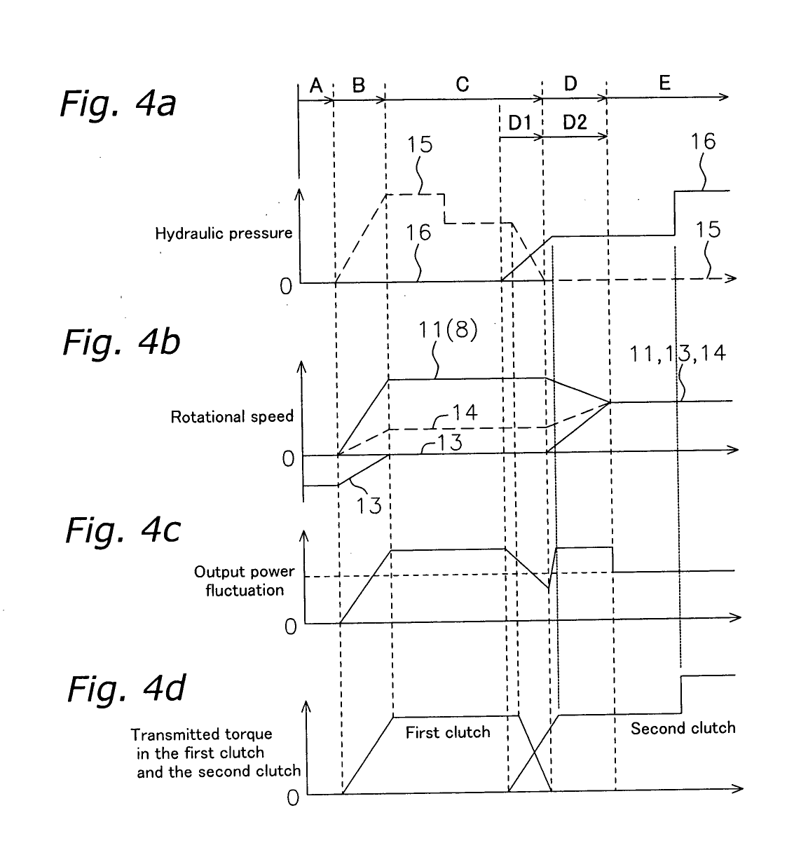

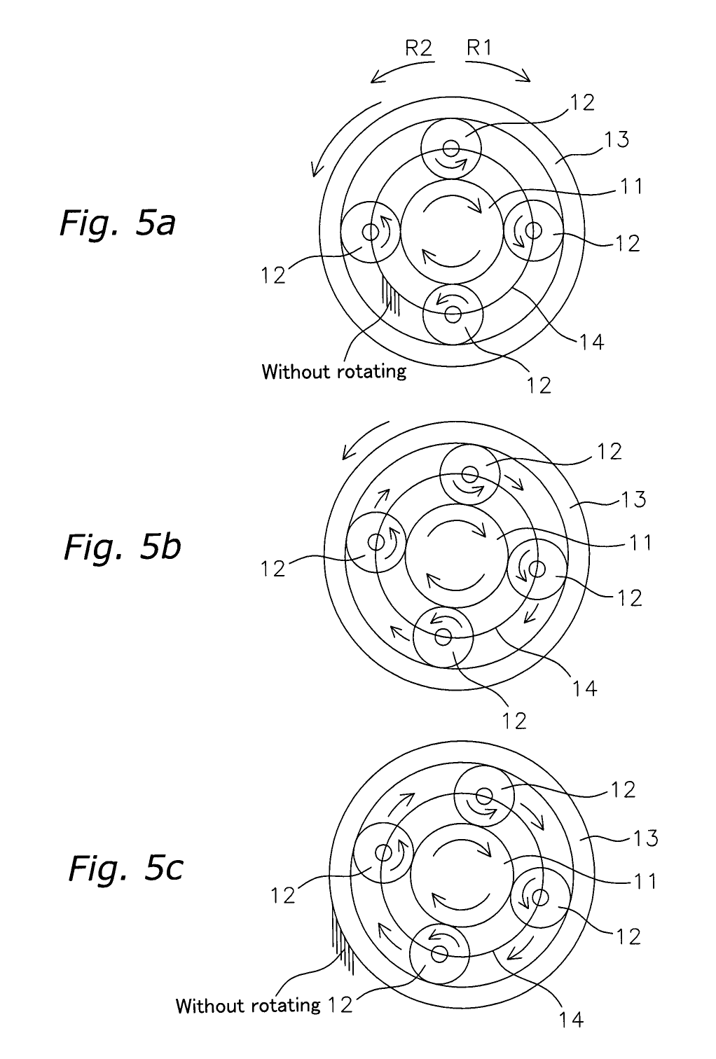

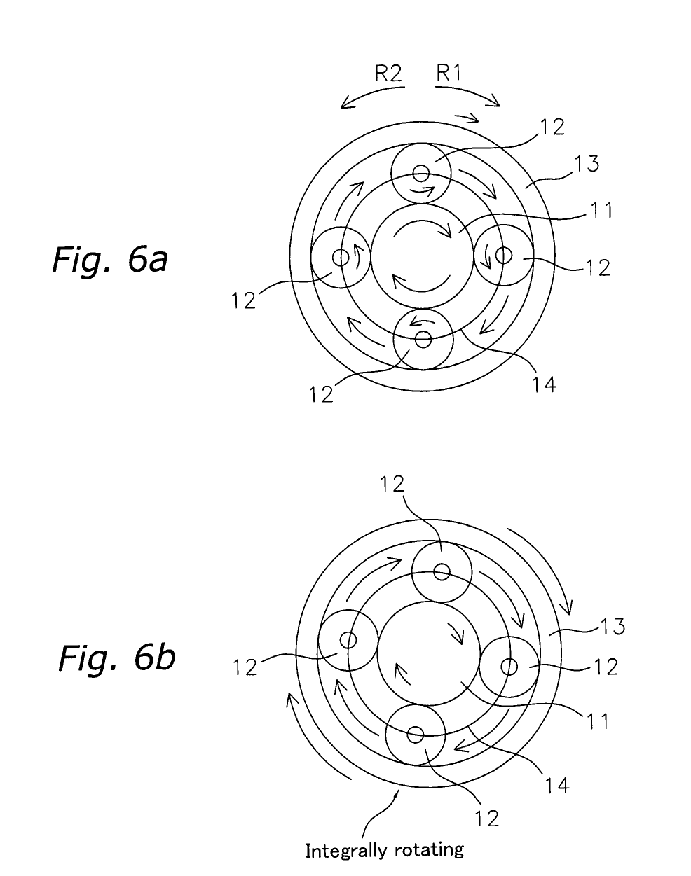

The operation of the power transmission device 1 will be described with reference to FIGS. 1 to 6. FIG. 3 shows a velocity diagram of the power transmission device 1. FIGS. 4a-4d show diagrams provided to explain gear shifting operations. FIGS. 5a to 6b show diagrams provided to explain the operation of the transmission mechanism 4. In FIG. 4, the horizontal axis represents time, and the vertical axis represents the hydraulic pressure, rotational speed, output power fluctuation (power fluctuation that is outputted from the carrier 14), and transmitted torque in the first clutch 15. FIGS. 5a to 6b show the operation of the sun gear 11, the pinion gears 12, the ring gear 13, and the carrier 14 seen from the engine 8. In FIGS. 5a to 6b, the rotational direction of the sun gear 11 is the direction R1, the direction opposite to the rotational direction of the sun gear 11 is the direction R2.

### (1) Idling Region A

As shown in FIG. 1, before the engine 8 starts, the first clutch 15 and the second clutch 16 are respectively disengaged. In addition, the switching mechanism 7 is coupled to the forward clutch 71, and the backward clutch 72 is decoupled. The transmission 9 is set at the initial state (for example, in the state that the reduction gear ratio is largest). When the engine 8 starts in this state, the sun gear 11 rotates via the output member 81, the flexible plate 82, and the damper mechanism 6. At the same time, since the first clutch 15 is disengaged, the ring gear 13 is rotatable relative to the housing 5. Since the second clutch 16 is also disengaged, the carrier 14 too is rotatable relative to the sun gear 11; that is, the sun gear 11, the pinion gears 12, and the ring gear 13 are rotatable relative to each other.

On the other hand, since the vehicle is in a stopped state, rotation of the members in the transmission 9 and the switching mechanism 7 are also at a halt, which means that the carrier 14 coupled to the input member 74 is unrotatable relative to the housing 5.

As described above, since the pinion gears 12 rotate on their axes without rotating around the sun gear 11, the ring gear 13 rotates in the direction R2 in accordance with rotation of the pinion gears 12 during the idling region after the start of engine 8 as shown in FIGS. 1, 3, 4(b), and 5(a).

### (2) Starting Region B and Low-Gear Running Region C

The first clutch 15 serves as the starting clutch when the vehicle starts. Specifically, as shown in FIG. 4(a), the hydraulic pressure for the first pressing mechanism 15a is regulated by the control valve to increase gradually so that the friction force generated between the first pressing mechanism 15a and the first friction member 15b also increases gradually. This friction force then gradually prevents the ring gear 13 from rotating. As the rotation of the ring gear 13 is prevented, the pinion gears 12 begin circuiting around the sun gear 11 in the direction R1 on their own axes (FIG. 5(b)). As a result, power is gradually transmitted from the sun gear 11 to the switching mechanism 7 and the transmission 9 via the pinion gears 12 and the carrier 14. At this time, power inputted to the sun gear 11 is amplified depending on the reduction gear ratio. Therefore, necessary power for the starting region B in the vehicle is transmitted to the transmission 9, and the vehicle starts to move forward (FIGS. 1, 3, 4(b), and 5(b)).

When the hydraulic pressure in the first clutch 15 reaches the prescribed value, the rotation of the ring gear 13 is completely stopped by the first clutch 15. Therefore, decreased rotational speed of the sun gear 11 is outputted as power to the switching mechanism 7 and the transmission 9. In such a case, the vehicle runs at a lower speed than the initial setting speed in the transmission 9 (the low-gear driving region C, FIGS. 1, 3, 4, and 5(c)).

Hereafter, the transmitted torque in the first clutch 15 will be described. The transmitted torque in the first clutch 15 is a necessary power for stopping the ring gear 13 from its rotation, and is received by the first clutch 15 in the direction R2 in the starting region B and a transition region D, whose explanation will be given below. This transmitted torque in the first clutch 15 gradually gets larger during the start of the vehicle, and is kept at a steady value after the first clutch 15 is completely engaged (FIG. 4(d)).

### (3) Transition Region D and High-Gear Running Region E

The switching operation to the high-gear starts in the latter half of the low-gear driving region C. Specifically, as shown in FIGS. 4a-4d, the hydraulic pressure in the second clutch 16 is regulated by the control valve to increase gradually. At this time, since the first clutch 15 is still coupled completely, a slide occurs in the second clutch 16, causing the friction force to generate in the second clutch 16. This also causes output power to gradually decrease depending on the amount of loss due to such friction force (the region D1, FIG. 4(c)).

At the same time, the hydraulic pressure in the first clutch 15 is regulated by the control valve to decrease gradually. As the friction force in the second clutch 16 gets larger, the pinion gears 12 start to rotate integrally with the sun gear 11. Thereby, power starts to be transmitted from the sun gear 11 to the ring gear 13 via the pinion gears 12. This power acts in the direction R1 that the transmitted torque in the first clutch 15 decreases. In conjunction with this phenomenon, the hydraulic pressure in the first clutch 15 is regulated to decrease, and the hydraulic pressure in the second clutch 16 is regulated to increase gradually so that the transmitted torque in the first clutch 15 gradually gets smaller (FIG. 4(d)), and the ring gear 13 starts rotating in the direction R1 (FIGS. 1, 4(c) and 6(a)). At the same time, as the difference of rotational speed between the sun gear 11 and the carrier 14 gradually decreases, rotational speed of the carrier 14 starts increasing (FIG. 1, 4(b)), and rotational speed in the engine starts to decrease.

Next, the second clutch 16 is coupled by increasing the hydraulic pressure in the second clutch 16 to a prescribed level. At this time, rotational speed of the sun gear 11 and the engine 8 decreases compared with the low running speed after starting. Therefore, torque according to the inertia force of the engine 8 is added to the then torque of the engine 8, and is outputted via the carrier 14 to be transmitted to the switching mechanism 7 and the transmission 9. In this state (the inertia region D2 in the transition region D), since the differences in rotational speeds among the sun gear 11, the carrier 14, and the ring gear 13 decrease to zero, the output power equals to the power from the engine 8. Hereby the acceleration operation completes, and the vehicle runs at the initial setting speed in the transmission 9 (the high-gear driving region E, FIGS. 1, 3, 4(b), and 6(b)).

### Effect

As described above, with this power transmission device 1, the transmission mechanism 4, the first clutch 15, and the second clutch 16 enable gear shifting in two stages. In the transmission mechanism 4, power is transmitted through the gears while slipping, i.e., useless increase of rotational speed in the engine typical of the hydrodynamic type devices, is prevented. This enables improvement of power transmission efficiency compared with hydrodynamic power transmission devices, while still securing a relatively smooth start for the vehicle.

Moreover, with this power transmission device 1, application of the planetary gear mechanism enables gear shifting in two stages with a simple structure, and allows compatibility with a conventional hydrodynamic power transmission device without upsizing the installation space to be maintained.

### Alternate Embodiments

Alternate embodiments will now be explained. In view of the similarity between the first and alternate embodiments, the parts of the alternate embodiments that are identical to the parts of the first embodiment will be given the same reference numerals as the parts of the first embodiment. Moreover, the descriptions of the parts of the alternate embodiments that are identical to the parts of the first embodiment may be omitted for the sake of brevity.

### 2. Second Embodiment

### Structure of Power Transmission Device

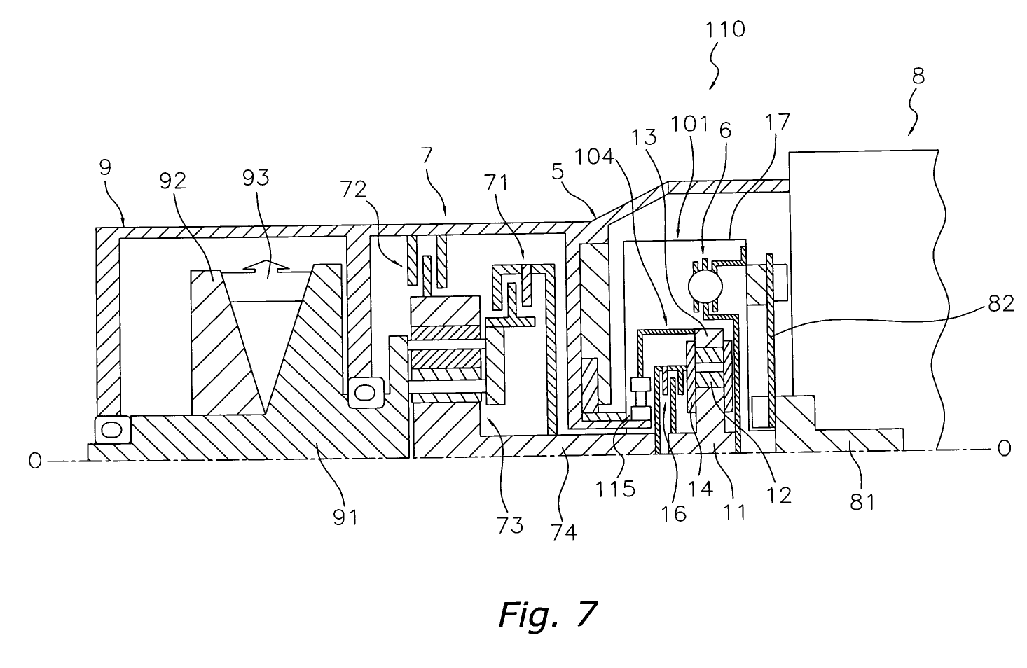

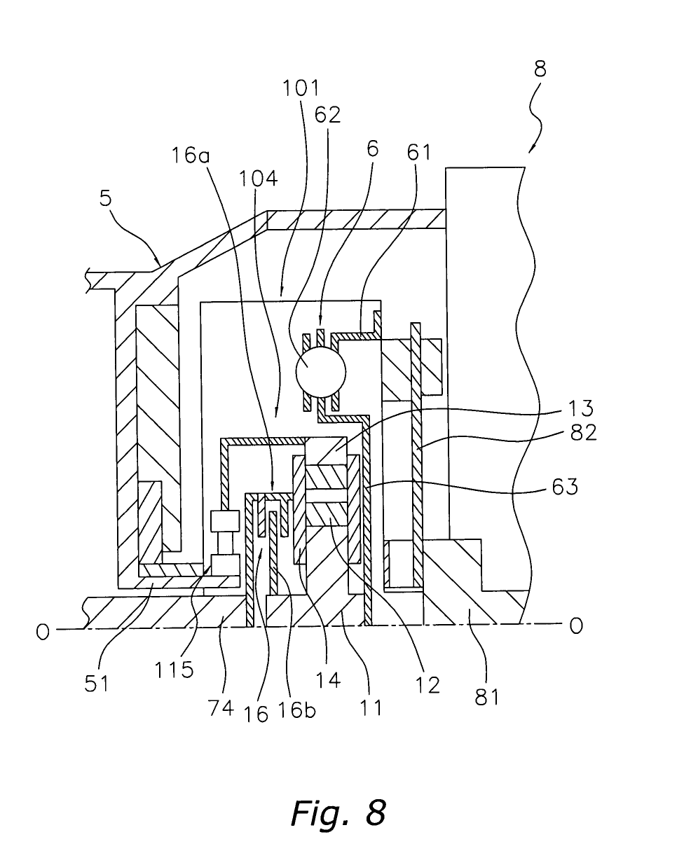

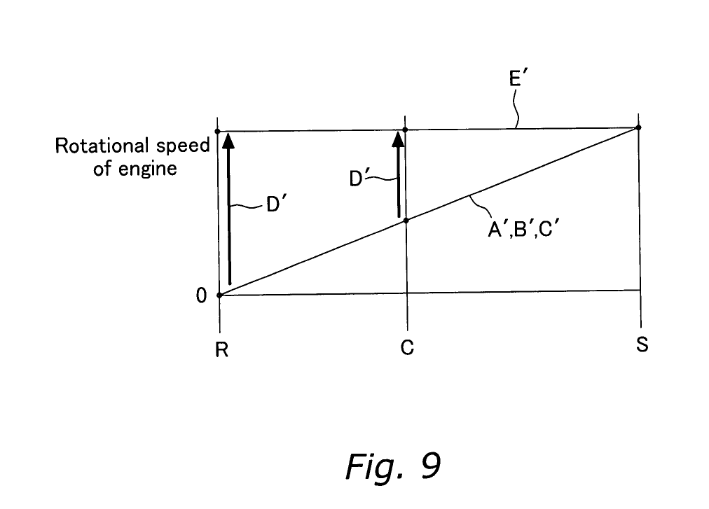

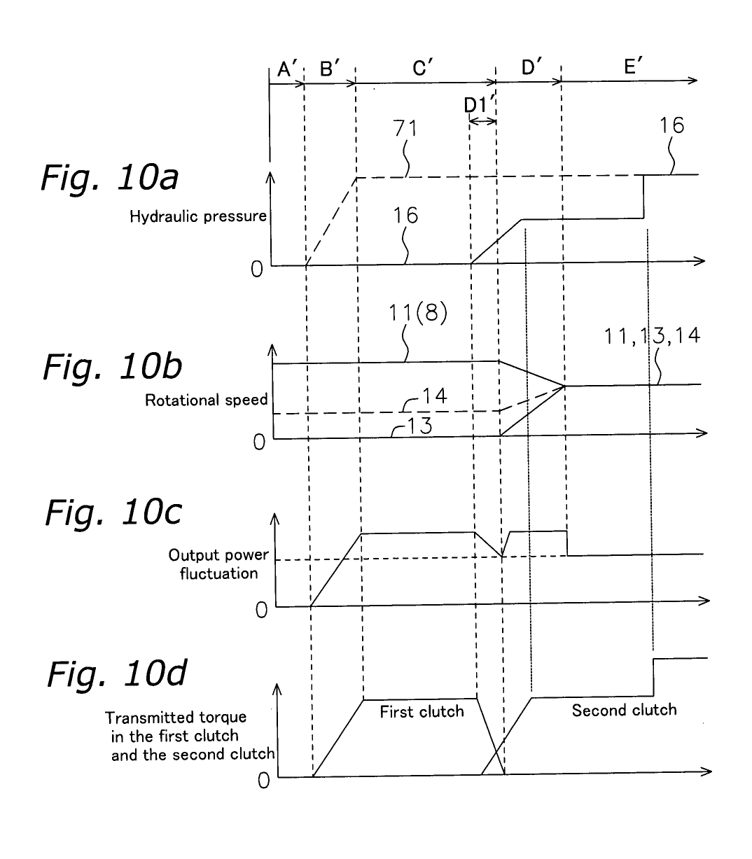

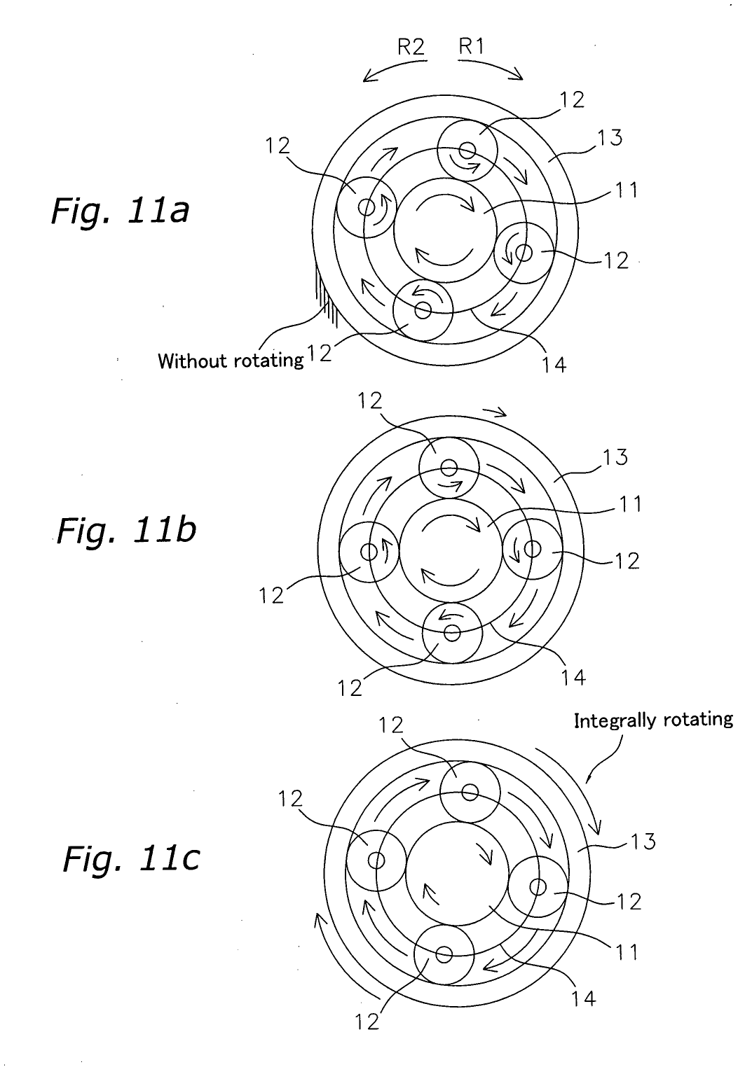

The power transmission device 101 according to the second embodiment of the present invention will be described with reference to FIGS. 7 to 11. In the above-mentioned embodiment, the ring gear 13 and the housing 5 are coupled by the first clutch 15. In this embodiment, however, a one-way clutch may be used. FIG. 7 shows a schematic cross-sectional view of an automatic transmission 110 with a power transmission device 101. FIG. 8 shows a schematic cross-sectional view of the power transmission device 101. FIG. 9 shows a velocity diagram of the power transmission device 101. FIG. 10 shows a diagram provided to explain the operation of the power transmission device 101 when shifting gears. FIG. 11 shows a diagram provided to explain the operation of a transmission mechanism 104. With regard to components of the second embodiment having the same or similar structures as those of the first embodiment, the same reference numbers used in the first embodiment will be used, and their descriptions will be omitted.

As shown in FIG. 7, the power transmission device 101 mainly includes the transmission mechanism 104, a first clutch 115, the second clutch 16, and the casing 17. The first clutch 115 is a one-way clutch, and supports the ring gear 13 to be rotatable relative to the cylindrical portion 51 of the housing 5 in only one direction. Specifically, the first clutch 115 allows the ring gear 13 to rotate in the only rotational direction of the sun gear 11.

### Operation of Power Transmission Device

The operation of the power transmission device 101 will be described with reference to FIGS. 9 to 11c.

(1) Idling region A′

The second clutch 16 is disengaged before the engine 8 starts. The switching mechanism 7 is coupled to the forward clutch 71, and the backward clutch 72 is also disengaged. When the engine 8 starts in this state, power is inputted to the sun gear 11 via the output member 81, the flexible plate 82, and the damper mechanism 6. At this time, the first clutch 115 prevents the ring gear 13 from rotating in the direction opposite to the rotational direction of the sun gear 11. Since the second clutch 16 is disengaged, the carrier 14 is rotatable relative to the sun gear 11. Also, since the forward clutch 71 and the backward clutch 72 are respectively disengaged, the input member 74 of the switching mechanism 7 is rotatable, though the rotation of the members of the transmission 9 is at a halt.

As described above, during the idling region A′ after the start of the engine 8, the carrier 14 and the input member 74 rotate at a lower speed in accordance with the rotation of the sun gear 11 as the transmission mechanism 104 serves as reduction gears, (FIGS. 7, 9, 10(b), and 11(a)).

### (2) Starting Region B′ and Low-Gear Running Region C′

Unlike the first embodiment, when the vehicle starts, the forward clutch 71 serves as a starting clutch in this embodiment. Specifically, as shown in FIG. 10(a), as the hydraulic pressure in the forward clutch 71 is regulated by the control valve to increase gradually (not shown), the friction force generated on the friction surface of the forward clutch 71 gets gradually higher too. At this time, since the forward clutch 71 prevents the input member 74 from rotating, torque acts on the ring gear 13 from the sun gear 11 via the pinion gears 12 in the direction R2, which is opposite to the rotational direction of the sun gear 11. As a result, the first clutch 115 is automatically engaged and prevents the ring gear 13 from rotating in the direction R2. Thereby, power inputted to the sun gear 11 via the pinion gears 12 and the carrier 14 is gradually transmitted to the switching mechanism 7 and the transmission 9, and the vehicle starts to move forward (FIGS. 7, 9, 10(b), and 11(a)). When the hydraulic pressure in the forward clutch 71 reaches the prescribed level, the vehicle runs at the lower speed than the low-gear of the transmission (the low-gear driving region C′, FIGS. 7, 9, 10, and 11(b)).

### (3) Transition Region D′ and High-Gear Running Region E′

After the vehicle starts moving, the acceleration starts. Specifically, as shown in FIGS. 10a to 10d, the hydraulic pressure in the second clutch 16 is regulated by the control valve to increase gradually. At this time, since the first clutch 115 prevents the ring gear 13 from rotating, sliding occurs in the second clutch 16, causing the generation of a friction force. This also causes output power to decrease gradually depending on the amount of loss due to such friction force (the region D1′, FIG. 10(c)).

As the friction force in the second clutch 16 gets larger, the pinion gears 12 start to rotate integrally with the sun gear 11. Thereby, power starts to be transmitted from the sun gear 11 to the ring gear 13 via the pinion gears 12. With these operations, the transmitted torque in the first clutch 115 gradually gets smaller (FIG. 10(d)).

As the friction force in the second clutch 16 further gets larger, the pinion gears 12 integrally rotate with the sun gear 11, and power that acts on the ring gear 13 in the direction R2 finally decreases to zero. Consequently, the ring gear 13 starts to rotate in the rotational direction of the sun gear 11. At the same time, the difference of rotational speed between the sun gear 11 and the carrier 14 decreases gradually, and rotational speed of the carrier 14 starts increasing (FIG. 10(b)). Since the inertia force of the vehicle is larger than the inertia force generated in the engine, the rotational speed of the engine 8 gradually decreases. Thereby, the inertia force generated in the engine 8 is outputted via the sun gear 11, the pinion gears 12, and the carrier 14 (the transition region D′, FIG. 10(c)).

Later, as the differences of rotational speed between the sun gear 11, the carrier 14, and the ring gear 13 decreases to zero, the output power equals the power from the engine 8. Hereby the acceleration operation completes, and the vehicle runs at the initial setting speed in the transmission 9, (the high-gear driving region E′, FIGS. 7, 9, 10(b), and 11(c)).

### Effect

As described above, with this power transmission device 101, the transmission mechanism 104, the first clutch 115, and the second clutch 16 enable gear shifting in two stages. In the transmission mechanism 104, power is transmitted via the gears instead of fluid. This enables improvement of power transmission efficiency compared with a hydrodynamic power transmission device, while still securing a relatively smooth start for the vehicle.

Moreover, with this power transmission device 101, applying the planetary gear mechanism enables gear shifting in two stages with a simple structure, and allows compatibility with the conventional hydrodynamic power transmission device to be maintained without upsizing the installation space.

Compared with the first embodiment, the power transmission device 101 can omit the controlled object (the first clutch 15). The same or similar effect as the one described above is still provided with simpler structures.

### 3. Other Embodiments

The specific structures of the present invention are not limited to the embodiments described above, and the various modifications and revisions are possible without departing the gist of the invention.

For example, the construction of the transmission 9 is not limited to a belt type CVT as described above, and the transmission may be a toroidal type CVT or AT.

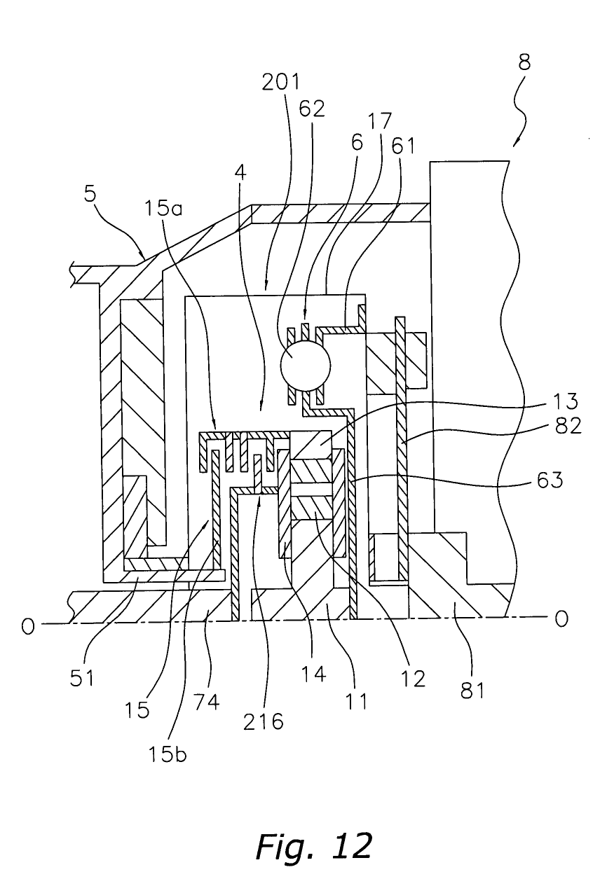

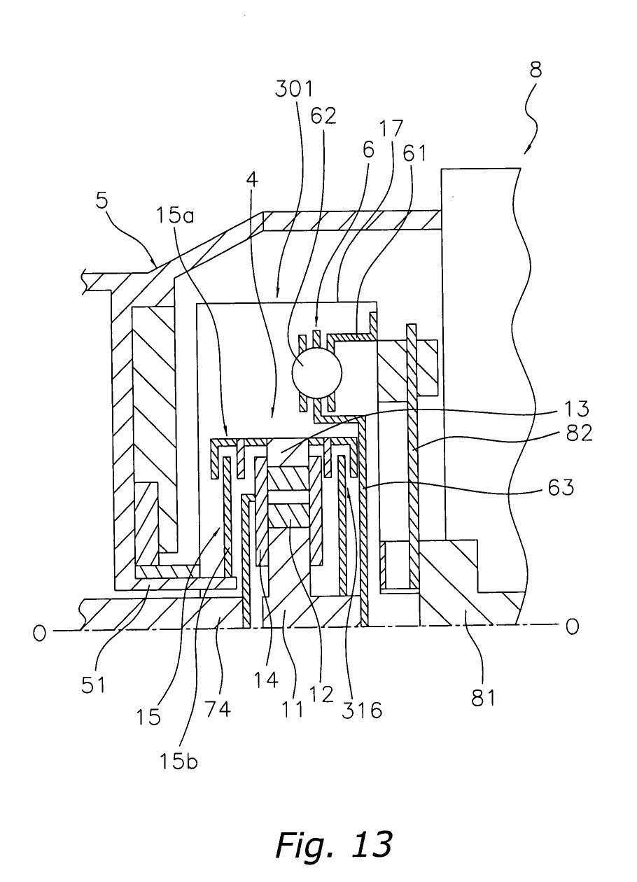

In the above-mentioned embodiments, the second clutch 16 can couple and decouple the sun gear 11 and the carrier 14. As shown in FIG. 12, however, a second clutch 216 in a power transmission device 201 can be configured to be capable of coupling and decoupling the ring gear 13 and the carrier 14, or as shown in FIG. 13, a second clutch 316 of a power transmission device 301 can be configured to be capable of coupling and decoupling the sun gear 11 and the ring gear 13. In both cases, the same or similar effect as that of the above mentioned embodiments is provided.

### General Interpretation of Terms

In understanding the scope of the present invention, the term “configured” as used herein to describe a component, section or part of a device that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers, and/or steps. The foregoing also applies to words having similar meanings such as the terms, “including,” “having,” and their derivatives. Also, the terms “part,” “section,” “portion,” “member,” or “element” when used in the singular can have the dual meaning of a single part or a plurality of parts. As used herein to describe the present invention, the following directional terms “forward, rearward, above, downward, vertical, horizontal, below, and transverse” as well as any other similar directional terms refer to those directions of a transmission device equipped with the present invention. Accordingly, these terms, as utilized to describe the present invention should be interpreted relative to a transmission device equipped with the present invention as normally used. Finally, terms of degree such as “substantially,” “about,” and “approximately” as used herein mean a reasonable amount of deviation of the modified term such that the end result is not significantly changed. For example, these terms can be construed as including a deviation of at least±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

1. A power transmission device to transmit power from an engine to a transmission, comprising:
a transmission mechanism being configured to transmit power with at least two kinds of rotational speed ratios varying in stages; and
at least two clutches being configured to shift the rotational speed ratio of the transmission mechanism.

2. The power transmission device according to claim 1, wherein the clutches are configured to participate in transmitting power indirectly.

3. The power transmission device according to claim 2, further comprising a housing, wherein
the transmission mechanism includes
a sun gear configured to receive power from the engine,
a ring gear arranged around the sun gear,
a plurality of pinion gears arranged between the sun gear and the ring gear to engage with the sun gear and the ring gear, and
a carrier coupling a member of the transmission and the plurality of pinion gears, and
the at least two clutches include
a first clutch configured to couple and to decouple the ring gear and the housing, and
a second clutch configured to couple and to decouple any two of the sun gear, the ring gear, and the carrier.

4. The power transmission device according to claim 3, further comprising a damper mechanism configured to couple elastically a member of the engine and a member of the transmission mechanism in the rotational direction.

5. The power transmission device according to claim 4, wherein the transmission includes a continuously variable transmission.

6. The power transmission device according to claim 2, further comprising
a housing, wherein
the transmission mechanism includes
a sun gear receiving power from the engine,
a ring gear arranged around the sun gear,
a plurality of pinion gears arranged between the sun gear and the ring gear to engage with the sun gear and the ring gear, and
a carrier coupled to the member of the transmission, and coupling the plurality of pinion gears,
the at least two clutches include
a first clutch configured to allow relative rotation between the ring gear and the housing in only one direction, and
a second clutch configured to couple and to decouple any two of the sun gear, the ring gear and the carrier.

7. The power transmission device according to claim 6, wherein the ring gear is rotatable relative to the housing in only the same direction as the rotational direction of the sun gear.

8. The power transmission device according to claim 7, further comprising a damper mechanism configured to couple elastically a member of the engine and a member of the transmission mechanism in the rotational direction.

9. The power transmission device according to claim 8, wherein the transmission includes a continuously variable transmission.

10. The power transmission device according to claim 1, further comprising a housing, wherein
the transmission mechanism includes
a sun gear configured to receive power from the engine,
a ring gear arranged around the sun gear,
a plurality of pinion gears arranged between the sun gear and the ring gear to engage with the sun gear and the ring gear, and
a carrier coupling a member of the transmission and the plurality of pinion gears, and
the at least two clutches include
a first clutch configured to couple and to decouple the ring gear and the housing, and
a second clutch configured to couple and to decouple any two of the sun gear, the ring gear, and the carrier.

11. The power transmission device according to claim 10, further comprising a damper mechanism configured to couple elastically a member of the engine and a member of the transmission mechanism in the rotational direction.

12. The power transmission device according to claim 11, wherein the transmission includes a continuously variable transmission.

13. The power transmission device according to claim 1, further comprising
a housing, wherein
the transmission mechanism includes
a sun gear receiving power from the engine,
a ring gear arranged around the sun gear,
a plurality of pinion gears arranged between the sun gear and the ring gear to engage with the sun gear and the ring gear, and
a carrier coupled to the member of the transmission, and coupling the plurality of pinion gears,
the at least two clutches include
a first clutch configured to allow relative rotation between the ring gear and the housing in only one direction, and
a second clutch configured to couple and to decouple any two of the sun gear, the ring gear and the carrier.

14. The power transmission device according to claim 13, wherein the ring gear is rotatable relative to the housing in only the same direction as the rotational direction of the sun gear.

15. The power transmission device according to claim 14, further comprising a damper mechanism configured to couple elastically a member of the engine and a member of the transmission mechanism in the rotational direction.

16. The power transmission device according to claim 15, wherein the transmission includes a continuously variable transmission.

17. The power transmission device according to claim 1, further comprising a damper mechanism configured to couple elastically a member of the engine and a member of the transmission mechanism in the rotational direction.

18. The power transmission device according to claim 17, wherein the transmission includes a continuously variable transmission.

19. The power transmission device according to claim 1, wherein the transmission includes a continuously variable transmission.
